(19) United States
(12) Patent Application Publication
(10) Pub. No.: US 2025/0390358 A1
(43) Pub. Date: Dec. 25, 2025

(54) STORAGE SYSTEM AND METHOD, AND HARDWARE OFFLOAD CARD

(71) Applicant: CLOUD INTELLIGENCE ASSETS HOLDING (SINGAPORE) PRIVATE LIMITED, Singapore (SG)

(72) Inventor: Saisai ZHANG, Hangzhou, Zhejiang (CN)

(21) Appl. No.: 18/879,718

(22) PCT Filed: Aug. 14, 2023
(86) PCT No.: PCT/CN2023/112985

§ 371 Date: Dec. 27, 2024

(30) Foreign Application Priority Data
Aug. 24, 2022 (CN) 202211021514.6

(51) Int. Cl. G06F 9/50; G06F 9/455; G06F 9/54

(52) U.S. Cl. CPC G06F 9/5066; G06F 9/45533; G06F 9/54

(57) ABSTRACT

Embodiments of the present application provide a storage system and method, and a hardware offload card, where the storage system includes a hardware offload card and a storage device, where the hardware offload card and the storage device are connected to a host in a peer-to-peer manner; the hardware offload card is configured to receive a storage task from the host, execute the storage task, and send a data access request corresponding to the storage task to the storage device; the storage device is configured to transmit storage data corresponding to the data access request based on a transmission channel between the host and the storage device.

### CROSS-REFERENCE TO RELATED APPLICATIONS

This application is a National Stage of International Application No. PCT/CN2023/112985, filed on Aug. 14, 2023, which claims priority to Chinese Patent Application No. 202211021514.6, filed to China National Intellectual Property Administration on Aug. 24, 2022 and entitled “STORAGE SYSTEM AND METHOD, AND HARDWARE OFFLOAD CARD”. The contents of the two applications are hereby incorporated by reference in their entireties.

### TECHNICAL FIELD

Embodiments of the present description relates to the field of computer technologies and, in particular, to a storage system.

### BACKGROUND

With the rapid development of big data analysis, artificial intelligence and other technologies, customers need more high-performance, high-availability, scalable and flexible storage capacity. However, in traditional local storage technology, input/output (IO) task processing of the virtual machine on the host and the backend occupies more central processing unit (CPU) resources, which makes it impossible to achieve high-performance IO and time delay.

At present, some schemes use pure software, which is flexible in implementation. By standardizing the software interface, the interaction between software and hardware of different device types can be unified. However, because of the standardization of the scheme, the characteristics of data transmission of different device types are ignored, and the efficiency is relatively low in some scenarios of large data transmission.

### SUMMARY

In view of this, embodiments of the present application provide a storage system. One or more embodiments of the present application simultaneously relate to a storage method, a hardware offload card, a computer-readable storage medium and a computer program, so as to solve the technical defects existing in the prior art.

According to a first aspect of the embodiments of the present application, a storage system is provided, which includes a hardware offload card and a storage device, where the hardware offload card and the storage device are connected to a host in a peer-to-peer manner; the hardware offload card is configured to receive a storage task from the host, execute the storage task, and send a data access request corresponding to the storage task to the storage device; the storage device is configured to transmit storage data corresponding to the data access request based on a transmission channel between the host and the storage device.

In an implementation, the hardware offload card includes a programmable system on chip and a dedicated hardware; the programmable system on chip is configured to identify software subtasks in the storage task and call a software processing logic running on the programmable system on chip to process the software subtasks; the dedicated hardware is configured to execute hardware subtasks in the storage task.

In an implementation, the programmable system on chip is further configured to identify a medium type of the storage device, and configure a corresponding interaction rule according to the medium type to enable generation of the data access request according to the interaction rule.

In an implementation, the dedicated hardware is further configured to establish a virtual device based on a virtual device simulation technology, and the virtual device is configured to abstract physical storage resources of the storage device and provide virtualized storage resources for the host.

In an implementation, the virtual device is configured to acquire the storage task from a memory address which is negotiated with the virtual machine of the host according to the memory address.

In an implementation, the dedicated hardware includes a storage protocol processing module, the storage protocol processing module is configured to parse a communication protocol format of the storage task sent by a virtual machine, and convert the communication protocol format of the storage task into a universal communication protocol format to enable a task entering the programmable system on chip to be in a universal communication protocol format.

In an implementation, a single storage device is abstracted into a plurality of virtual devices, where different virtual devices correspond to different virtual machines in the host, and the plurality of virtual machines share the storage resources of the single storage device; the programmable system on chip includes a multi-tenant shared task processing module, the multi-tenant shared task processing module is configured to respectively and correspondingly allocate storage tasks of the plurality of virtual machines to different storage areas of the single storage device, and perform authority verification and access address isolation on the storage tasks.

In an implementation, the host includes a virtual machine, and a memory is arranged in the virtual machine; a transmission channel between the memory of the virtual machine and the storage device is a direct memory access (DMA) transmission channel; the storage device is configured to directly access a memory of the virtual machine through DMA to transmit the storage data corresponding to the data access request.

In an implementation, the hardware offload card is configured to save the data access request in a memory of the hardware offload card; the storage device is configured to directly access the memory of the hardware offload card through DMA to obtain the data access request.

In an implementation, the software processing logic operated by the programmable system on chip includes a logic of pooling processing of storage resources, cache acceleration processing, access request error processing and/or hardware operation and maintenance processing.

According to a second aspect of the embodiments of the present application, a storage method is provided, which is applied to a hardware offload card, and the hardware offload card and a storage device are connected to a host in a peer-to-peer manner, and the method includes: receiving a storage task from the host; executing the storage task; and sending a data access request corresponding to the storage task to the storage device to enable the storage device to transmit storage data corresponding to the data access request based on a transmission channel between the host and the storage device.

According to a third aspect of the embodiments of the present application, a hardware offload card is provided, which includes a memory and a processor; where the memory is configured to store computer-executable instructions, and the processor is configured to execute the computer-executable instructions, the computer-executable instructions, when executed by the processor, implement the steps of the storage method described in any embodiment of the present application.

According to a fourth aspect of the embodiments of the present application, a computer-readable storage medium is provided, which stores computer-executable instructions that, when executed by a processor, implement the steps of the storage method described in any embodiment of the present application.

An embodiment of the present application provides a storage system, which includes a hardware offload card and a storage device, where the hardware offload card and the storage device are connected to a host in a peer-to-peer manner, the hardware offload card is configured to receive a storage task from the host, execute the storage task, and send a data access request corresponding to the storage task to the storage device, and the storage device is configured to transmit storage data corresponding to the data access request based on a transmission channel between the host and the storage device. It can be seen that in this storage system, the storage task is offloaded to the hardware offload card, and the hardware is used to accelerate the execution, which reduces the occupation of the host CPU resources, and the task processing efficiency is higher. Moreover, because the storage device obtains the data access request from the hardware offload card in a peer-to-peer manner, which is equivalent to separating the transmission of the storage data from the processing of the storage task by the hardware offload card, and the storage task that the hardware offload card is responsible for executing is a control-related task and does not carry the storage data. The transmission of the storage data does not need to go through the hardware offload card, and the storage device directly transmits the storage data corresponding to the data access request to the host, thus realizing a processing strategy of separation of data and control, achieving a performance close to a physical hardware level, and achieving higher performance IO and time delay.

### BRIEF DESCRIPTION OF DRAWINGS

FIG. 1 is a structural block diagram of a storage system provided by an embodiment of the present application.

FIG. 2 is a structural block diagram of a storage system provided by another embodiment of the present application.

FIG. 3 is a structural block diagram of a host provided by an embodiment of the present application.

FIG. 4 is a schematic diagram of a cloud multi-tenant application scenario of a storage system provided by an embodiment of the present application.

FIG. 5 is a flowchart of a storage method provided by an embodiment of the present application.

FIG. 6 is a structural block diagram of a computing device provided by an embodiment of the present application.

### DESCRIPTION OF EMBODIMENTS

In the following description, numerous specific details are set forth to facilitate a thorough understanding of the present application. However, the present application can be implemented in many other ways different from those described here, and those skilled in the art can make similar promotion without violating the connotation of the present application, so the present application is not limited by the specific implementation disclosed below.

Terminology used in one or more embodiments of the present application is for the purpose of describing specific embodiments only and is not intended to limit one or more embodiments of the present application. The singular forms “a”, “the” and “this” used in one or more embodiments of the present application and the appended claims are also intended to include the plural forms, unless the context clearly indicates other meaning. It should also be understood that the term “and/or” used in one or more embodiments of the present application refers to and includes any or all possible combinations of one or more associated listed items.

It should be understood that although the term first, second, etc. may be used to describe various information in one or more embodiments of the present application, these information should not be limited to these terms. These terms are only used to distinguish the same type of information from each other. For example, without departing from the scope of one or more embodiments of the present application, the first can also be called the second, and similarly, the second can also be called the first. Depending on the context, the word “if” as used herein can be interpreted as “when” or “when” or “in response to determining that”.

First, the terminology involved in one or more embodiments of the present application is explained.

Local disk: a local disk device based on the physical machine where the virtual machine is located, which provides storage access capability with high storage input/output operations per second (IOPS) and low read and write time delay.

Hardware offload card: a processing card that is independent of the host CPU and used to perform tasks. The hardware offload card can be based on graphics processing unit (GPU)/field programmable gate array (FPGA)/application specific integrated circuit (ASIC)/system on a programmable chip (SOC) and other heterogeneous hardware implementations, and is configured to shift tasks to hardware processing. In the present application, the hardware offload card may include capabilities including virtualization offload, algorithm acceleration and protocol stack offload.

PCIe bus: a kind of high-speed serial computer expansion bus, which has a transmission bus supporting large bandwidth, high performance, low I/O pins and small physical space.

Solid state drive (SSD): an electronic storage drive based on solid-state architecture. SSD has built-in NAND and NOR flash memories for storing non-volatile data.

Hard disk drive (HDD): a non-volatile computer storage device, which contains high-speed rotating disks or disks, and is an auxiliary storage device for permanently storing data.

With the rapid development of big data analysis, artificial intelligence and other technologies, customers need more high-performance, high-availability, scalable and flexible storage capacity. For example, a storage task processing scheme is a pure software scheme based on virtio/vhost/vhost-user. Virtio is an abstract layer above devices in the semi-virtualized virtual machine monitor. Vhost is a virtual host. Vhost-user is a backend of virtio. The virtio/vhost/vhost-user scheme is essentially a software-defined virtual device, which is flexible in implementation. By standardizing the software interface, the interaction between software and hardware of different device types can be unified. However, because of the standardization of the scheme, the characteristics of data transmission of different device types are ignored, and the efficiency is relatively low in some scenarios of large data transmission. At the same time, because the virtualization simulation and IO processing in the pure software scheme occupy more CPU resources, the performance cannot be comparable to that of physical storage devices.

Thus, in the present application, a storage system is provided, and the present application also relates to a storage method, a hardware offload card, and a computer-readable storage medium, which will be described in detail in the following embodiments one by one.

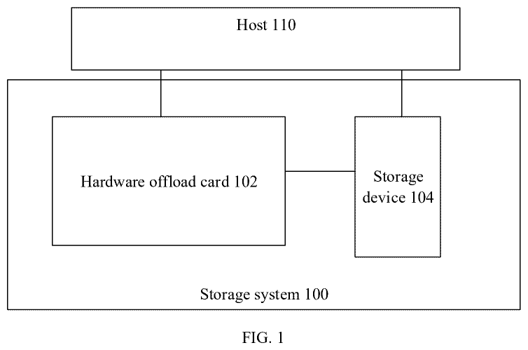

Referring to FIG. 1, FIG. 1 illustrates a structural block diagram of a storage system provided by an embodiment of the present application. The storage system 100 includes a hardware offload card 102 and a storage device 104. The hardware offload card 102 is connected to the host 110 in a peer-to-peer manner with the storage device 104.

The peer-to-peer connection means that the hardware offload card 102 and the storage device 104 are at the same level of the transmission protocol. The implementation of the peer-to-peer connection is not limited. For example, in practical application, in order to support the peer-to-peer connection of the hardware offload card and the storage device to the host, the hardware offload card and the storage device can be hung under a same PCIe converter of the host as peer hardware entities.

The hardware offload card 102 is configured to receive a storage task from the host 110, execute the storage task, and send a data access request corresponding to the storage task to the storage device 104.

The storage task refers to a task related to the operation and use of storage devices and/or access to storage data. For example, it may include health monitoring, operation and maintenance, data reading/writing, data encryption/decryption, data compression, cyclic redundancy check, database operators, etc. of storage devices. The data access request may be information carried in the storage task when the virtual machine sends the storage task, or information generated when the hardware offload card executes the storage task. The storage task can be described by metadata, which is used to carry information representing the content of the storage task. When the data access request corresponding to the storage task is a write request, data to be written will not be directly brought together in the metadata, but will carry location information of the data to be written, and correspondingly, the corresponding generated data access request will carry the location information. In this way, the storage device can make a request to the host according to the data access request to obtain the data to be written from the corresponding location.

The data access request may include a read and/or write request for the storage data in the storage device. In the case that the data access request is a write request, in order to realize separation of data and control, the data access request does not carry the data to be written, but can carry the location information of the data to be written on the host, so that the storage device can directly obtain the storage data stored in the storage location from the host. The implementation of the hardware offload card sending the data access request to the storage device is not limited. For example, in order to accelerate the access, the hardware offload card can write the data access request into a memory of the hardware offload card, and the storage device can obtain the data access request from the memory. Specifically, the hardware offload card 102 may be configured to save the data access request in the memory of the hardware offload card. The storage device is configured to directly access the memory of the hardware offload card through DMA to obtain the data access request. The data access request carries an address of the data to be accessed.

The storage device 104 is configured to transmit storage data corresponding to the data access request based on a transmission channel between the host 110 and the storage device 104.

The transmission channel between the host 110 and the storage device 104 may be based on a physical link connection of peripheral component interconnect express (PCIe, high-speed serial computer expansion bus standard). The storage device can be understood as one or more physical hard disks of any one or more medium types.

The hardware offload card 102 and the storage device 104 can communicate through a bus channel. For example, when the hardware offload card performs a storage task, it is necessary to read and write the storage data of the storage device in some scenarios, then the hardware offload card 102 can be configured to access the storage data of the storage device through a bus channel.

In this storage system, the storage task is offloaded (the offloading can be understood as transferring) to the hardware offload card, and the hardware is used to accelerate the execution of the storage task, which reduces the occupation of the host CPU resources, and the task processing efficiency is higher. Moreover, because the storage device obtains the data access request from the hardware offload card in a peer-to-peer manner, the data access request does not carry the storage data, which is equivalent to separating the transmission of the storage data from the processing of the storage task by the hardware offload card. For the transmission of the storage data of the storage device, the hardware offload card is bypassed, so that the storage device directly transmits the storage data corresponding to the data access request to the host, thus realizing a processing strategy of separation of data and control, and the data does not need to be forwarded through the hardware offload card. Because a large number of storage data does not need to be copied and circulated in the transmission from the host to the hardware offload card and then to the physical storage device for many times, it avoids the excessive requirements on the task processing ability and resource processing ability of the hardware offload card, and reduces the bus traffic burden of the hardware offload card, thus achieving a performance close to a physical hardware level, realizing the acceleration of the storage control plane and the data plane, and achieving higher performance IO and time delay.

In the storage system provided by the embodiments of the present application, in order to avoid the storage task consuming the host CPU resources, the storage task is processed by hardware offloading to realize acceleration. Because not all storage tasks are suitable for hardware acceleration, such as control plane tasks and processing for specific scenarios, more flexibility is needed. However, fixed operation instructions and memory access instructions, large-scale data processing, etc. are suitable for hardware acceleration. Therefore, in order to improve the system performance and make the delay index meet the system requirements, in the embodiments of the present application, the hardware offload card is realized by software and hardware collaboration.

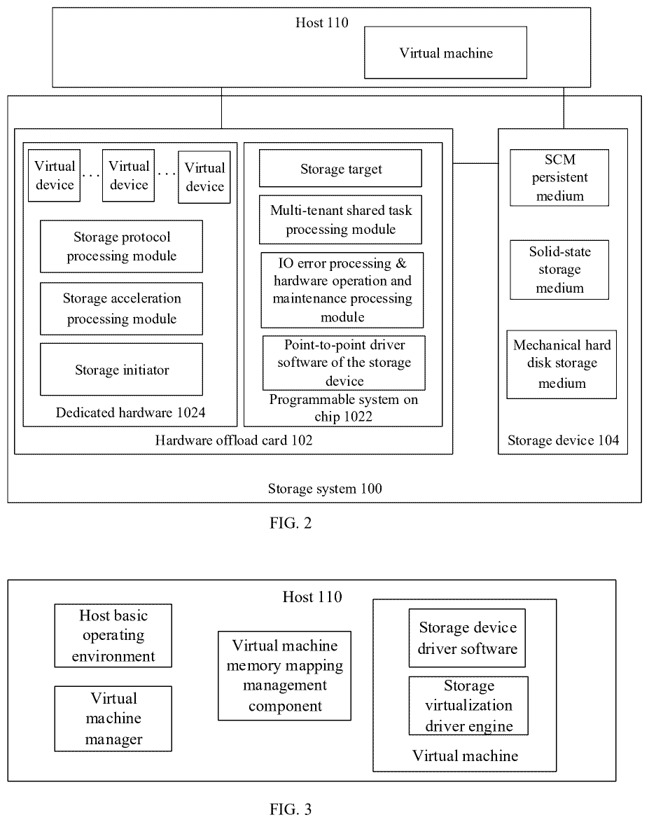

Specifically, refer to FIG. 2, which illustrates a structural block diagram of a storage system provided by another embodiment of the present application. The hardware offload card 102 includes a programmable system on chip 1022 and dedicated hardware 1024.

The programmable system on chip 1022 can be configured to identify software subtasks in the storage task and call a software processing logic running on the programmable system on chip to process the software subtasks.

The programmable system on chip 1022 (i.e., programmable SOC) can run

a control logic to identify the software subtasks in the storage task, and when the software subtasks are identified, the programmable system on chip calls a corresponding software processing logic to execute the software subtasks. The control logic can be represented as a program software in the programmable system on chip, where the software processing logic can be flexibly set according to the processing needs of the software subtasks in actual application scenarios. For example, the software processing logic operated by the programmable system on chip includes an access request error processing logic and/or a hardware operation and maintenance processing logic.

In addition, in practical application, in order to support the hardware offload card and the storage device to be connected to the host in a peer-to-peer manner, the hardware offload card and the storage device are hung under a same PCIe converter of the host as peer hardware entities. Accordingly, as shown in the structural block diagram of FIG. 2, the programmable system on chip may include a point-to-point driver software of the storage device. The point-to-point driver software of the storage device can also be understood as a PCIe point-to-point driver software. Through the point-to-point driver software of the storage device, the ability of the storage device to access a memory address space of the hardware offload card through DMA can be realized. Furthermore, the storage device can access the data access request stored in the memory after the hardware offload card is processed. After the storage device obtains the data access request, it can obtain the address of the data to be written in the host memory or the address of the data to be read in the storage device by analyzing the format of the data access request, so that the storage device can directly access the address space where the data is located and accelerate the data plane.

The dedicated hardware 1024 may be configured to execute hardware subtasks in the storage task.

A hardware processing logic of the dedicated hardware 1024 can be specifically set according to the processing needs of hardware subtasks in actual application scenarios. The dedicated hardware 1024 can be implemented by any dedicated acceleration hardware according to the needs of the scenarios. For example, the dedicated hardware 1024 can be embodied as ASIC/FPGA and other dedicated hardware.

In practical applications, the dedicated hardware 1024 can be used to provide accelerated processing capabilities of various types of hardware subtasks. For example, as shown in FIG. 2, the dedicated hardware 1024 may include a storage acceleration processing module configured to accelerate data read/write tasks, security checks (such as password checks, etc.), and the like.

In this embodiment, software subtasks in the storage task are identified, so that the parts that are not suitable for hardware acceleration are identified as software subtasks, the hardware subtasks that are suitable for hardware acceleration are offloaded to special hardware processing, and the parts that are not suitable for hardware acceleration are offloaded to the programmable system on chip for processing by software, thus realizing a general software-hardware interaction and collaboration framework, and flexibly configuring the storage task as pure software processing or special accelerated hardware processing.

In the embodiments of the present application, the specific implementation of the software processing logic running in the programmable system on chip and the hardware processing logic running in the dedicated hardware is not limited, and can be set according to the tasks suitable for software or hardware execution. For example, the software processing logic may include a logic of pooling processing of storage resources, cache acceleration processing, access request error processing and/or hardware operation and maintenance processing. Accordingly, as shown in the structural block diagram of FIG. 2, the programmable system on chip 1022 may include an IO error processing & hardware operation and maintenance processing module.

Specifically, an access request error processing task may include processing strategies for abnormal access requests (such as timeout IO, error IO and invalid IO). For example, the access request error processing task can intercept the access request to the back-end storage device when the hardware of the back-end storage device is abnormal or fault, so as to prevent the virtual machine from abnormal downtime caused by accessing an invalid address space. A hardware operation and maintenance processing task may include operation and maintenance strategies for abnormal physical hardware (such as storage failure of the storage device, transmission failure of the storage device, etc.). For example, a hardware operation and maintenance processing task module can be connected to a cloud operation and maintenance center, and report abnormal physical hardware to the cloud operation and maintenance center and a computer room, so as to realize offline maintenance and online processing of abnormal physical hardware. Pooling means that the storage resources of the underlying storage devices are pooled and merged to form a storage resource pool, which is divided or combined according to the storage capacity required by users after pooling. Cache acceleration refers to using high-speed medium as a cache of low-speed medium to provide accelerated access for low-speed medium. For example, supporting SSD can realize fast access, while HDD has large storage space and slow access speed. SSD can be used as cache and HDD can be used as data storage disk to solve the problem of the slow access speed of HDD.

Because the software subtasks are executed by the programmable system on chip, the software processing logic corresponding to the software subtasks can be flexibly set in the software program of the programmable system on chip. For example, parameters and strategies of software processing logic such as health monitoring and operation and maintenance strategy can be customized in the program. In addition, the programmable system on chip can also read physical disk data through PCIe channel to meet the local disk operation and maintenance requirements.

In practical applications, the medium types of storage devices can be varied. In order to support storage systems with multiple medium types, in one or more embodiments of the present application, combined with the above software and hardware collaboration ideas, in order to achieve more efficient local disk hardware acceleration, a storage system supporting multi-medium and separation of data and control can be realized through the following embodiments. Specifically, the programmable system on chip 1022 can also be configured to identify a medium type of the storage device, and configure a corresponding interaction rule according to the medium type to enable generation of the data access request according to the interaction rule. Specifically, for example, as shown in FIG. 2, the dedicated hardware may include a storage initiator. The storage initiator may be configured to interface with the programmable system on chip 1022. After the hardware offload card is started, the storage initiator will automatically negotiate with the storage target inside the programmable system on chip 1022 to determine the communication protocol with the back-end storage device. The storage target inside the programmable system on chip 1022 can identify and manage the back-end storage devices (including identifying the medium type of the storage devices), and when the storage initiator detects the back-end storage devices, it will automatically negotiate with the storage initiator to determine a communication protocol to be adopted when interacting with the storage device. After confirming the communication protocol, a transmission channel from the storage initiator to the storage target is created accordingly.

For example, the medium type of the storage device may include any one or more medium types such as storage class memory (SCM) persistent medium, solid-state storage medium and mechanical hard disk storage medium. For example, the interaction rule may include any one or more rules related to the interaction of storage devices, such as communication protocols and device drivers. The hardware offload card can load the protocol or software corresponding to the interaction rule, so that the hardware offload card can interact with the corresponding storage device.

Through the storage system provided by the above embodiments, various types of local disk scenarios and innovation of local disk form in the future can be supported simultaneously, and protocol processing and IO processing can be sunk into a dedicated accelerated hardware chip at the same time to realize hardware-level performance and time delay.

It should be noted that the communication protocol used for interaction may be different for storage devices with different storage medium types. According to the above embodiments, the software running on the programmable system on chip in the hardware offload card can flexibly configure the interaction rule, and the hardware offload card can interact with different types of storage medium. However, the data to be read and written is not limited by the communication protocol, and the storage device can directly transmit with the host.

According to the above embodiments, although different storage medium may follow different protocols and different message formats, in the embodiments of the present application, the interaction rule is recognized by the software running on the programmable system on chip, written into the configuration of the hardware offload card, and then the hardware offload card interacts with the storage medium according to the configured rule. In this way, various forms of local disks can be supported, and hard disks of different forms can be mounted on the PCIe bus of the host. On one hand, the dynamic scalability of hard disk mounting can be realized, on the other hand, the iteration of the disk and the iteration of the hardware offload card can be realized independently. For example, storage tasks such as storage virtualization, storage protocol processing and background management tasks can be offloaded to the hardware offloading card for processing, and a processing capacity can be provided through the software and hardware collaboration of the hardware offloading card, so that the linear expansion and scalability of the storage device and more advanced storage functions can be realized. It is not limited to a specific storage medium, and multiple medium types such as NVMe SSD and HDD can be supported at the same time, which has high versatility.

In order to flexibly adapt to application scenarios such as multi-tenancy, the dedicated hardware 1024 can also be configured to establish a virtual device based on a virtual device simulation technology, and the virtual device is configured to abstract physical storage resources of the storage device and provide virtualized storage resources for the host. Specifically, as shown in the structural block diagram of the storage system in FIG. 2, based on the virtual device simulation of the dedicated hardware 1024, the hardware offload card 102 may also include a plurality of virtual devices based on the virtual device simulation technology. Because the virtual device is virtual hardware simulated based on the IO virtualization capability of the hardware offload card, a single physical storage device can be virtualized into multiple virtual devices, and the virtual devices can be mounted in multiple virtual machines of the host, so that multi-tenants can share access to the physical devices in the cloud.

In this embodiment, while realizing the performance of hardware IO, the physical storage resources of the storage device are abstracted inside the hardware offload card, and virtualized storage resources are provided for the host, so that the forms of the front-end virtual disk and the back-end physical disk are separated and decoupled, and various innovations of the back-end physical disk forms are supported. For example, although the bottom storage device is an HDD disk, an NVME disk is presented to the upper layer through the virtual device. Based on virtualization, multiple virtual devices can meet the multi-tenant scenarios in cloud computing services, which brings great convenience to the operation and migration in cloud computing scenarios. For example, virtual device simulation can be realized based on single root I/O virtualization (SR-IOV) technology. SR-IOV technology is a hardware-based virtualization solution, which can improve performance and scalability. SR-IOV standard allows efficient sharing of PCIe devices among virtual machines, and because it is implemented in hardware, it can achieve I/O performance comparable to that of the native machine.

Considering that when the host sends a storage task to the hardware offload card, if sending through a host software stack, it is difficult to avoid some processing of the host software stack, resulting in low processing efficiency. Therefore, in one or more embodiments of the present application, as shown in the structural block diagram of the storage system in FIG. 2, the host 110 includes a virtual machine, where the virtual device is configured to acquire the storage task from a memory address which is negotiated with the virtual machine of the host according to the memory address. For example, the virtual device and the virtual machine can discuss in advance the memory address for storing storage tasks, and the storage tasks described by metadata can be stored in an area corresponding to the memory address. Because the virtual machine sends the storage task to the memory storage area which is previously discussed with the hardware offload card, the hardware offload card can directly go to the area to obtain the storage task, bypassing the host software stack, and improving the processing efficiency.

For the virtual machine in the host, the access protocol to the storage device in the virtual machine is completely separated and decoupled from the back-end physical storage device. The IO protocol formats of different virtual machines can be different. In order to enable the dedicated hardware in the hardware offload card and/or the programmable system on chip to identify the protocol formats of the storage tasks of different virtual machines, as shown in FIG. 2, the dedicated hardware 1024 includes a storage protocol processing module. The storage protocol processing module is configured to parse a communication protocol format of the storage task sent by a virtual machine, and convert the communication protocol format of the storage task into a universal communication protocol format to enable a task entering the programmable system on chip to be in a universal communication protocol format.

It should be noted that any module in the dedicated hardware, such as the storage protocol processing module, can be combined with other modules of the dedicated hardware, or set separately from other modules, which is not limited in the present application. For example, the storage protocol processing module is set separately from other modules and receives storage tasks from various virtual devices for protocol processing.

Based on the embodiment that virtual devices are arranged inside the hardware offload card, in practical application, in order to meet the needs of multi-tenants to share the storage resources of a single storage device, a single storage device can be abstracted into a plurality of virtual devices as needed, where different virtual devices correspond to different virtual machines in the host, and the plurality of virtual machines share the storage resources of the single storage device. Accordingly, in order to make the virtual machines of the host only access the specified hardware resources and prevent malicious IO access from invading the whole storage system, the programmable system on chip 1022 includes a multi-tenant shared task processing module, the multi-tenant shared task processing module is configured to correspondingly allocate the storage tasks of the different virtual machines sharing the storage resources to different storage areas of the single storage device, and perform authority verification and access address isolation on the storage tasks.

The authority verification can be the verification of the tenant's authority, such as access authority, data processing authority and so on. The access address isolation refers to isolating the access addresses of different storage areas corresponding to different virtual machines to avoid malicious IO access.

In addition, in order to improve the data transmission efficiency between the storage device and the host, in one or more embodiments of the present application, the data transmission between the host and the storage device avoids overhead such as memory copying by directly accessing the virtual machine memory through DMA. Specifically, the host includes a virtual machine, and a memory is arranged in the virtual machine. The data transmitted between the host and the storage device can be placed in the memory of the virtual machine. The transmission channel between the host and the storage device is a DMA transmission channel. The storage device is configured to directly access a memory of the virtual machine through DMA to transmit the storage data corresponding to the data access request.

In the following, the application of internal components of the host is taken as an example to further explain the implementation of the storage system with reference to FIG. 3. FIG. 3 illustrates a structural block diagram of a host provided by an embodiment of the present application. As shown in FIG. 3, internal components of the host may include the following components.

A host basic operating environment, configured to provide an environment in which a basic physical server runs.

A virtual machine manager, configured to manage resource allocation, life cycle, etc. of a virtual machine. For example, through the virtual machine manager, multiple virtual machines can be set to share host hardware resources.

A virtual machine memory mapping management component, configured to manage a mapping relationship between a memory address inside the virtual machine and a memory address on the host, so that an application software inside the virtual machine does not need to be aware of a virtualization layer when running.

A virtual machine including a storage device driver software and a storage virtualization driver engine. The storage device driver software is a hardware device driver running inside the virtual machine, which is configured to provide an internal application of the virtual machine with an ability to access a storage hardware. The storage virtualization driver engine is configured to interface with a virtual simulation device provided by a hardware offload card, so that the virtual machine does not need to perceive that a bottom layer is virtual device hardware or real hardware when accessing the storage hardware.

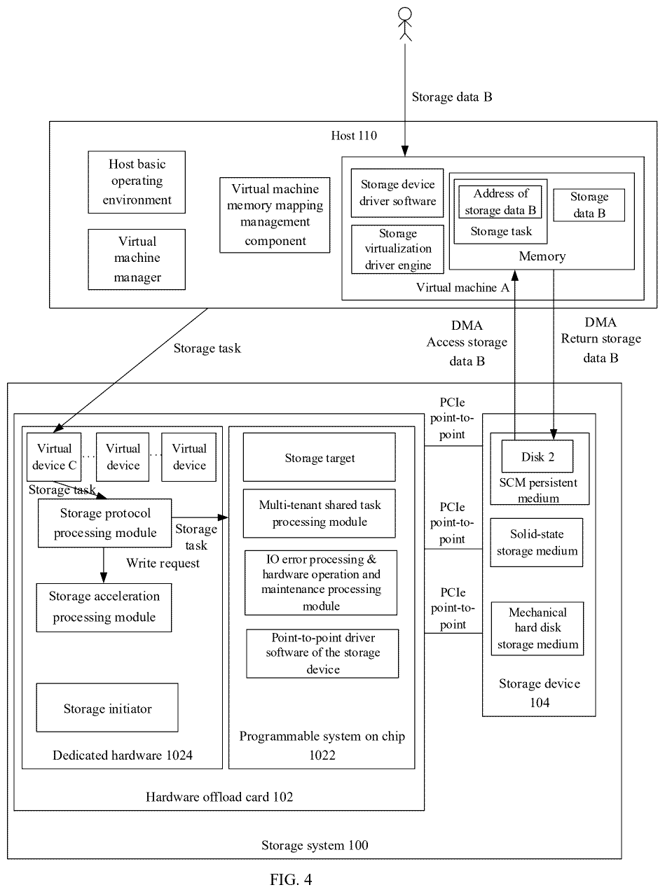

In order to make the storage system provided by the embodiments of the present application easier to understand, the following is a description of a multi-tenant application scenario on the cloud of a storage system provided by the embodiments of the present application in conjunction with FIG. 4. As shown in FIG. 4, the host 110 is any cloud host on a cloud computing platform. A virtual device C in the hardware offload card 102 is abstracted from a hard disk “Disk 2” of a SCM persistent medium. The virtual device C is mounted in a virtual machine A to support the tenants in the virtual machine A to use storage resources of the hard disk “Disk 2”. When the hardware offload card 102 is started, a storage initiator in the hardware offload card 102 detects the “Disk 2”, and automatically negotiates with a storage target in the programmable system on chip 1022 to determine the communication protocol with the “Disk 2”. By configuring the communication protocol of the SCM persistent medium, a transmission channel between the hardware offload card and the “Disk 2” is established.

Tenants use virtual machine A to issue a storage task of “writing storage data B to the underlying storage of the virtual machine”. Virtual machine A carries an address of storage data B in the virtual machine memory in the storage task, and writes the storage task into a section of memory space that the virtual machine and virtual device C have discussed in advance. After the virtual device C obtains the storage task from the memory of the virtual machine, it sends the storage task to a storage protocol processing module. Because the message format of the storage task follows the communication protocol used by the virtual machine A, the storage protocol processing module converts the storage task into a general communication protocol format. The storage protocol processing module sends the storage task in general communication protocol format to the programmable system on chip. The programmable system on chip recognizes that there is a software subtask “multi-tenant shared task” in the storage task, calls the multi-tenant shared task processing module to perform authority verification and access address isolation on the storage task, and determines that the storage data B needs to be written into the storage area XX of the Disk 2. Therefore, the data access request corresponding to the storage task is a write request “writing the storage data B to the storage area XX of the Disk 2”, and the write request carries the address of the storage data B in the virtual machine memory of the host. The write request is generated according to the communication protocol of the “Disk 2” and stored in the memory address space of the hardware offload card. The Disk 2 accesses the memory address space of the hardware offload card through DMA and obtains the write request. According to the memory address of the storage data B carried by the write request, the Disk 2 directly accesses the memory of the virtual machine A through DMA to obtain the storage data B, and writes the storage data B into the Disk 2.

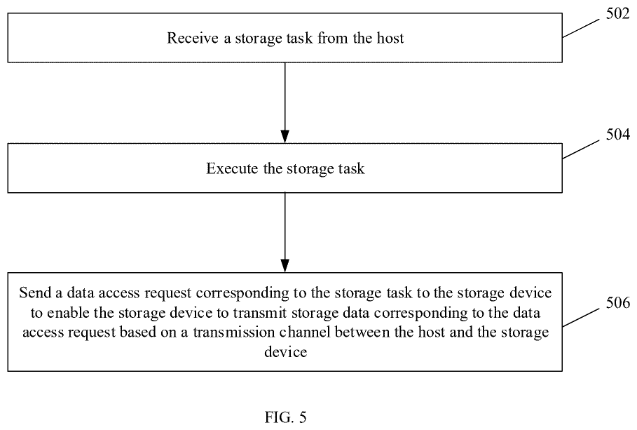

Corresponding to the above-mentioned storage system embodiments, the present application also provides a storage method embodiment applied to the hardware offload card, and FIG. 5 illustrates a flowchart of a storage method provided by an embodiment of the present application. As shown in FIG. 5, the method includes:
step 502: receive a storage task from the host;
step 504: execute the storage task; and
step 506: send a data access request corresponding to the storage task to the storage device to enable the storage device to transmit storage data corresponding to the data access request based on a transmission channel between the host and the storage device.

According to this method, the storage task is offloaded to the hardware offload card, and the hardware is used to accelerate the execution, which reduces the occupation of the host CPU resources, and the task processing efficiency is higher. Moreover, because the storage device obtains the data access request from the hardware offload card in a peer-to-peer manner, which is equivalent to separating the transmission of the storage data from the processing of the storage task by the control logic of the hardware offload card, and the storage device directly transmits the storage data corresponding to the data access request to the host, thus realizing a processing strategy of separation of data and control, and the data does not need to be forwarded through the hardware offload card, thus achieving a performance close to a physical hardware level, and achieving higher performance IO and time delay.

The above is a schematic scheme of a storage method of this embodiment. It should be noted that the technical scheme of the storage method belongs to the same concept as the technical scheme of the storage system mentioned above, and details not described in detail in the technical scheme of the storage method can be found in the description of the technical scheme of the storage system mentioned above.

For example, the storage method may include a software processing part and a hardware processing part, where the software processing part corresponds to the processing of the programmable system on chip of the storage system, and the hardware processing part corresponds to the processing of the dedicated hardware of the storage system. For details, please refer to the description of the technical scheme in the above storage system, which will not be discussed in detail here.

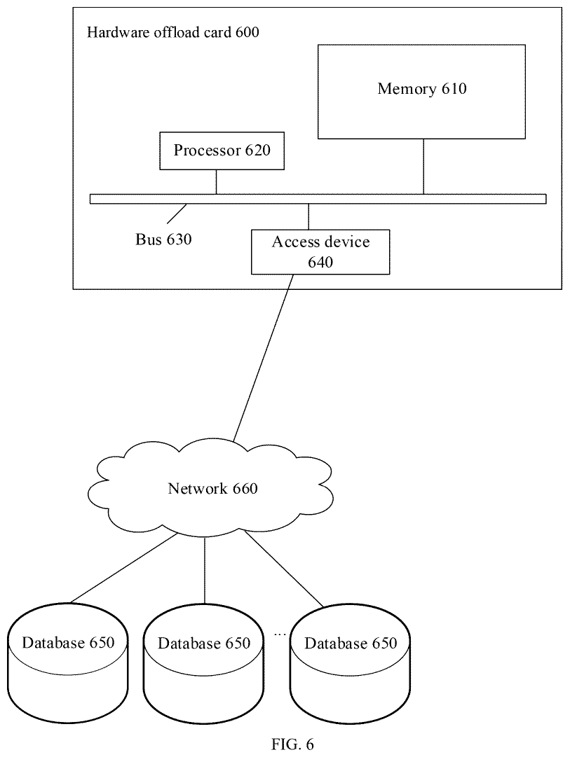

FIG. 6 illustrates a structural block diagram of a hardware offload card 600 provided by an embodiment of the present application. Components of the hardware offload card 600 include, but are not limited to, a memory 610 and a processor 620. The processor 620 is connected with the memory 610 through a bus 630, and a database 650 is used to store data.

The hardware offload card 600 also includes an access device 640 that enables the hardware offload card 600 to communicate via one or more networks 660. Examples of these networks include the public switched telephone network (PSTN), local area network (LAN), wide area network (WAN), personal area network (PAN) or a combination of communication networks such as the Internet. The access device 640 may include one or more of any type of wired or wireless network interfaces (e.g., network interface card (NIC)), such as IEEE802.11 wireless local area network (WLAN) wireless interface, worldwide interoperability for microwave access (Wi-MAX) interface, Ethernet interface, universal serial bus (USB) interface, cellular network interface, Bluetooth interface, near field communication (NFC) interface, etc.

In an embodiment of the present application, the above components of the hardware offload card 600 and other components not shown in FIG. 6 may also be connected to each other, for example, through a bus. It should be understood that the structural block diagram of the hardware offload card shown in FIG. 6 is only for the purpose of example, and is not a limitation on the scope of the present application. Those skilled in the art can add or replace other components as needed.

The processor 620 is used to execute computer-executable instructions which, when executed by the processor, realize the steps of the above storage method.

The above is a schematic scheme of a computing device of this embodiment. It should be noted that the technical scheme of the computing device belongs to the same concept as the technical scheme of the above storage method, and details not described in detail in the technical scheme of the computing device can be referred to the description of the technical scheme of the above storage method.

An embodiment of the present application also provides a computer-readable storage medium storing computer-executable instructions which, when executed by a processor, implement the steps of the above storage method.

The above is a schematic scheme of a computer-readable storage medium of this embodiment. It should be noted that the technical scheme of the storage medium belongs to the same concept as the technical scheme of the above storage method, and details not described in detail in the technical scheme of the storage medium can be referred to the description of the technical scheme of the above storage method.

An embodiment of the present application also provides a computer program, where when the computer program is executed in a computer, the computer is caused to execute the steps of the above storage method.

The above is a schematic scheme of a computer program of this embodiment. It should be noted that the technical scheme of the computer program belongs to the same concept as the technical scheme of the above storage method, and details not described in detail in the technical scheme of the computer program can be found in the description of the technical scheme of the above storage method.

Specific embodiments of the present application have been described above. Other embodiments are within the scope of the appended claims. In some cases, the actions or steps recited in the claims may be performed in a different order than in the embodiments and still achieve the desired results. In addition, the processes depicted in the drawings do not necessarily require the specific order shown or the sequential order to achieve the desired results. In some embodiments, multitasking and parallel processing are also possible or may be advantageous.

The computer instructions include computer program codes, which can be in source code form, object code form, executable file or some intermediate form, etc. The computer-readable medium may include any entity or device, recording medium, U disk, mobile hard disk, magnetic disk, optical disk, computer memory, Read-Only Memory (ROM), Random Access Memory (RAM), electric carrier signal, telecommunication signal, software distribution medium, etc., which are capable of carrying the computer program codes. It should be noted that the contents contained in the computer-readable medium can be appropriately increased or decreased according to the requirements of legislation and patent practice in the jurisdiction. For example, in some jurisdictions, according to legislation and patent practice, the computer-readable medium does not include electric carrier signals and telecommunication signals.

It should be noted that for the sake of simple description, all the aforementioned method embodiments are expressed as a series of action combinations, but those skilled in the art should know that the described action sequence is not limited to the embodiments in the present application, because some steps can be performed in other sequences or at the same time according to the embodiments in the present application. Secondly, those skilled in the art should also know that the embodiments described in the present application are all preferred embodiments, and the actions and modules involved are not necessarily necessary for the embodiments in the present application.

In the above-mentioned embodiments, the description of each embodiment has its own emphasis. For the parts not detailed in one embodiment, please refer to the relevant descriptions of other embodiments.

The preferred embodiments of the present application disclosed above are only used to help explain the present application. The above embodiments do not describe all the details in detail, nor are they limited to the specific embodiments described. Obviously, many modifications and changes can be made according to the contents of the embodiments in the present application. These embodiments are selected and described in detail in the present application in order to better explain the principles and practical applications of the embodiments in the present application, so that those skilled in the technical field can better understand and make use of the present application. The present application is limited only by the claims and their full scope and equivalents.

1. A storage system, comprising: a hardware offload card and a storage device, wherein the hardware offload card and the storage device are connected to a host in a peer-to-peer manner;
the hardware offload card is configured to receive a storage task from the host, execute the storage task, and send a data access request corresponding to the storage task to the storage device;
the storage device is configured to transmit storage data corresponding to the data access request based on a transmission channel between the host and the storage device.

2. The storage system according to claim 1, wherein the hardware offload card comprises a programmable system on chip and a dedicated hardware;
the programmable system on chip is configured to identify software subtasks in the storage task and call a software processing logic running on the programmable system on chip to process the software subtasks;
the dedicated hardware is configured to execute hardware subtasks in the storage task.

3. The storage system according to claim 2, wherein the programmable system on chip is further configured to identify a medium type of the storage device, and configure a corresponding interaction rule according to the medium type to enable generation of the data access request according to the interaction rule.

4. The storage system according to claim 2, wherein the dedicated hardware is further configured to establish a virtual device based on a virtual device simulation technology, and the virtual device is configured to abstract physical storage resources of the storage device and provide virtualized storage resources for the host.

5. The storage system according to claim 4, wherein the virtual device is configured to acquire the storage task from a memory address which is negotiated with the virtual machine of the host according to the memory address.

6. The storage system according to claim 5, wherein the dedicated hardware comprises a storage protocol processing module, the storage protocol processing module is configured to parse a communication protocol format of the storage task sent by a virtual machine, and convert the communication protocol format of the storage task into a universal communication protocol format to enable a task entering the programmable system on chip to be in a universal communication protocol format.

7. The storage system according to claim 4, wherein a single storage device is abstracted into a plurality of virtual devices, wherein different virtual devices correspond to different virtual machines in the host, and the plurality of virtual machines share the storage resources of the single storage device;
the programmable system on chip comprises a multi-tenant shared task processing module, and the multi-tenant shared task processing module is configured to respectively and correspondingly allocate storage tasks of the plurality of virtual machines to different storage areas of the single storage device, and perform authority verification and access address isolation on the storage tasks.

8. The storage system according to claim 1, wherein the host comprises a virtual machine, and a memory is arranged in the virtual machine; a transmission channel between the memory of the virtual machine and the storage device is a direct memory access (DMA) transmission channel;
the storage device is configured to directly access a memory of the virtual machine through DMA to transmit the storage data corresponding to the data access request.

9. The storage system according to claim 1, wherein the hardware offload card is configured to save the data access request in a memory of the hardware offload card;
the storage device is configured to directly access the memory of the hardware offload card through DMA to obtain the data access request.

10. The storage system according to claim 2, wherein the software processing logic operated by the programmable system on chip comprises a logic of pooling processing of storage resources, cache acceleration processing, access request error processing and/or hardware operation and maintenance processing.

11. A storage method, applied to a hardware offload card, wherein the hardware offload card and a storage device are connected to a host in a peer-to-peer manner, the method comprises:
receiving a storage task from the host;
executing the storage task; and
sending a data access request corresponding to the storage task to the storage device to enable the storage device to transmit storage data corresponding to the data access request based on a transmission channel between the host and the storage device.

12. A hardware offload card, comprising:
a memory and a processor;
wherein the memory is configured to store computer-executable instructions, and the processor is configured to execute the computer-executable instructions, the computer-executable instructions, when executed by the processor, cause the processor to:
receive a storage task from the host;
execute the storage task; and
send a data access request corresponding to the storage task to the storage device to enable the storage device to transmit storage data corresponding to the data access request based on a transmission channel between the host and the storage device.

13. A non-transitory_computer-readable storage medium storing computer-executable instructions which, when executed by a processor, implement the steps of the storage method according to claim 11.

14. The storage method according to claim 11, further comprising:
identifying software subtasks in the storage task and calling a software processing logic running on the programmable system on chip to process the software subtasks; and
executing hardware subtasks in the storage task.

15. The storage method according to claim 14, further comprising:
identifying a medium type of the storage device, and configuring a corresponding interaction rule according to the medium type to enable generation of the data access request according to the interaction rule.

16. The storage method according to claim 14, further comprising:
establishing a virtual device based on a virtual device simulation technology; and
abstracting physical storage resources of the storage device and providing virtualized storage resources for the host.

17. The storage method according to claim 16, further comprising:
acquiring the storage task from a memory address which is negotiated with the virtual machine of the host according to the memory address.

18. The storage method according to claim 17, further comprising:
parsing a communication protocol format of the storage task sent by a virtual machine, and converting the communication protocol format of the storage task into a universal communication protocol format to enable a task entering the programmable system on chip to be in a universal communication protocol format.

19. The storage method according to claim 16, wherein a single storage device is abstracted into a plurality of virtual devices, wherein different virtual devices correspond to different virtual machines in the host, and the plurality of virtual machines share the storage resources of the single storage device;
the storage method further comprises:
respectively and correspondingly allocating storage tasks of the plurality of virtual machines to different storage areas of the single storage device, and performing authority verification and access address isolation on the storage tasks.

20. The storage method according to claim 11, wherein the host comprises a virtual machine, and a memory is arranged in the virtual machine; a transmission channel between the memory of the virtual machine and the storage device is a direct memory access (DMA) transmission channel;
the storage method further comprises:
directly accessing a memory of the virtual machine through DMA to transmit the storage data corresponding to the data access request.
